(19) United States
(12) Patent Application Publication
(10) Pub. No.: US 2015/0137798 A1
(43) Pub. Date: May 21, 2015

(54) RELATIVE ROTATIONAL ANGULAR DISPLACEMENT DETECTION DEVICE, TORQUE DETECTION DEVICE, TORQUE CONTROL DEVICE, AND VEHICLE

(71) Applicant: Yamaha Hatsudoki Kabushiki Kaisha, Iwata-shi (JP)

(72) Inventors: Hiroshi TANAKA, Iwata-shi (JP); Kazuto NAKAMURA, Iwata-shi (JP)

(73) Assignee: YAMAHA HATSUDOKI KABUSHIKI KAISHA, Iwata-shi (JP)

(21) Appl. No.: 14/606,615

(22) Filed: Jan. 27, 2015

Related U.S. Application Data
(63) Continuation-in-part of application No. PCT/JP2013/074981, filed on Sep. 17, 2013.
Application No. PCT/JP2013/074981 is a continuation-in-part of application No. 14/024,078, filed on Sep. 11, 2013, now abandoned.

(30) Foreign Application Priority Data
Sep. 14, 2012 (JP) 2012-202580

(51) Int. Cl. G01D 5/14; B62D 5/04; B62K 11/04; H02P 23/00; A61G 5/04

(52) U.S. Cl. CPC G01D 5/142; H02P 23/004; A61G 5/041; B62K 11/04; B62D 5/04
USPC 324/207.2; 318/490

(57) ABSTRACT

A permanent magnet includes magnetic poles that are arranged so as to alternate in polarity in the circumferential direction of the axis of rotation. The magnet is attached to one of a pair of rotatable members. The rotatable members are relatively rotatable about an axis of rotation. A magnetic flux guiding ring, including an annular ring body and a plurality of protruding portions protruding from the ring body, is attached to the other rotatable member. A plurality of magnetic sensors is arranged adjacent to the ring body. A first facing portion and a second facing portion, each for guide part of magnetic fluxes of the ring body, are provided and do not rotate with the permanent magnet and the magnetic flux guiding ring.

### CROSS-REFERENCE TO RELATED APPLICATIONS

This is a continuation-in-part of U.S. application Ser. No. 14/024,078, filed Sep. 11, 2013, which claims priority under 35 U.S.C. §119 to Japanese Patent Application No. 2012-202580, filed on Sep. 14, 2012, and PCT Patent Application No. PCT/JP2013/074981 filed on Sep. 17, 2013, the subject matter of which is incorporated herein by reference.

### BACKGROUND OF THE INVENTION

1. Field of the Invention

The present invention relates to, inter alia, a relative rotational angular displacement detection device used to detect a relative rotational angular displacement of a pair of rotatable members arranged coaxially with each other.

More specifically, the present invention relates to a relative rotational angular displacement detection device preferably for use in a power assist system for, e.g., a power assist wheelchair, a power assist bicycle, a power steering wheel, etc. The present invention also relates to a torque detection device including the relative rotational angular displacement detection device, and a torque control device including the relative rotational angular displacement detection device. It also relates to a power assist wheelchair, a power assist straddle-type vehicle, and a power steering device equipped with the torque control device.

2. Description of the Related Art

For example, in a conventional manual wheelchair, a pair of hand rims are arranged outside of a pair of right and left rear wheels, respectively, and coaxially connected thereto. When a user rotates the hand rim, the rotational force is transmitted to the wheel to move the wheelchair. In recent years, for the purpose of reducing the burden of moving the hand rim by a user, a power assist system has been developed, in which the most appropriate assisting force corresponding to the manual force for moving the hand rim is transmitted to a driving wheel by an electric motor.

According to this system, the manual force for moving the hand rim of the wheelchair and the rotational force of the electric motor outputted in accordance with the manual force are combined to rotate the wheels, which enables easy moving of the wheelchair. This kind of power assist system may be applied not only to a wheelchair but also to a power assist bicycle, a power steering device of an automobile, etc.

This kind of power assist system is provided with a detection device for sensing a torque by detecting a relative rotational angular displacement of a pair of rotatory members coaxially arranged with each other in a relatively movable manner. As a device for detecting such a relative rotational angular displacement or a relative rotational torque, Japanese Unexamined Laid-open Patent Application Publication No. 2008-249366 discloses the following device. The device includes a pair of first and second shaft members arranged coaxially with each other, a cylindrical magnet fixed to the first shaft member, a pair of yoke rings fixed to the second shaft member, a pair of magnetic flux collector rings each arranged so as to surround each yoke ring and each having a magnetic flux collecting projection, and a magnetic sensor arranged between the magnetic flux collecting projections and configured to detect magnetic flux changes occurring in the yoke rings in accordance with the relative angular displacements of the first and second shaft members.

In the relative rotational angular displacement detection device, the first shaft member is coaxially provided with the cylindrical magnet so as to rotate together with the first shaft member. The cylindrical magnet includes plural pairs of magnetic poles, i.e., N-poles and S-poles, magnetized in a radial direction of an axis of rotation and arranged in a circumferential direction of the axis of rotation such that N-poles and S-poles appear alternately on outer peripheral surface of the cylindrical magnet. The second shaft member is provided with the pair of yoke rings which rotate together with the second shaft member. Each yoke ring includes triangular shaped magnetic pole claws corresponding to the N-poles and S-poles.

Each magnetic pole claw is arranged outside of the cylindrical magnet so as to face the pole of the cylindrical magnet in the radial direction of the axis of rotation. The pair of yoke rings are arranged such that the magnetic pole claws of one of the yoke rings and the magnetic pole claws of the other of the yoke rings are arranged so as to oppose in an axial direction of the axis of rotation and arranged alternately in the circumferential direction. A pair of magnetic flux collector rings each for collecting the magnetic fluxes generated in each yoke ring are arranged radially outside of the corresponding yoke rings.

When the first shaft member and the second shaft member are relatively rotated, the relative position of each yoke ring relative to the magnetic pole of the cylindrical magnet is changed. This causes magnetic flux changes between the magnetic flux collector rings. The magnetic flux changes are detected by the magnetic sensor.

### SUMMARY OF THE INVENTION

In the aforementioned detection device, the pair of yoke rings are provided so as to rotate together with the second shaft member. On the other hand, the two magnetic flux collector rings are fixed to the housing. In other words, the pair of yoke rings are structured so as to rotate relative to the two magnetic flux collector rings. Therefore, for enabling the changes in the magnetic fluxes to be detected with a high degree of accuracy, the pair of yoke rings and the two annular magnetic flux collector rings are formed into annular shapes, and arranged in the radial direction of the axis of rotation with a gap therebetween. However, since each of the members is formed into an annular shape with the accuracy of the gap ensured, the cost for manufacturing and assembling the detection device has been high.

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a relative rotational angular displacement detection device simple in structure and simple in assembly work and capable of detecting a relative rotational angular displacement of a pair of rotatable members arranged coaxially with each other with a high degree of accuracy.

Among other potential advantages, some embodiments can provide a torque detection device including the relative rotational angular displacement detection device, and a torque control device including the relative rotational angular displacement detection device.

Among other potential advantages, some embodiments can provide a power assist wheelchair, a power assist straddle-type vehicle, and a power steering device equipped with the torque control device.

Other objects and advantages of the present invention will be apparent from the following preferred embodiments.

According to some embodiments of the present invention, a relative rotational angular displacement detection device includes, as main structural members, a pair of rotatable members, a permanent magnet, a magnetic flux guiding ring, and a magnetic detection unit.

The relative rotational angular displacement detection device includes a pair of rotatable members rotatable by 360 degrees or more about an axis of rotation and relatively rotatable in a circumferential direction, and a permanent magnet attached to one of the pair of rotatable members and including magnetic poles arranged so as to alternate in polarity in the circumferential direction of the axis of rotation.

The relative rotational angular displacement detection device further includes a magnetic flux guiding ring. This magnetic flux guiding ring includes an annular ring body attached to the other of the pair of rotatable members and arranged coaxially with the axis of rotation and a plurality of protruding portions protruding from the ring body and arranged at positions facing the magnetic poles in a magnetization direction of the permanent magnet.

The relative rotational angular displacement detection device further includes a magnetic detection unit configured to detect magnetic fluxes of the ring body of the magnetic flux guiding ring magnetized depending on a relative position of each protruding portion of the magnetic flux guiding ring and each magnetic pole of the permanent magnet.

The magnetic detection unit includes a first facing portion arranged to face a part of the ring body to guide magnetic fluxes of the part of the ring body, a second facing portion arranged at a position apart from the first facing portion in a circumferential direction of the axis of rotation to guide magnetic fluxes of a part of the ring body, a first magnetic sensor configured to detect the magnetic fluxes guided by the first facing portion, and a second magnetic sensor configured to detect the magnetic fluxes guided by the second facing portion. The first facing portion and the second facing portion are fixed in the circumferential direction of the axis of rotation regardless of rotation of the permanent magnet and the magnetic flux guiding ring about the axis of rotation. The relative positions of the first facing portion and the second facing portion with respect to the circumferential direction of the axis of rotation are fixed independently of rotation of the permanent magnet and the magnetic flux guiding ring about the axis of rotation.

In some exemplary embodiments of the relative rotational angular displacement detection device, the first facing portion and the second facing portion are arranged at such positions that the central angle formed between the first facing portion and the second facing portion satisfies a relational expression of [(the value in mechanical angle corresponding to one cycle in electrical angle of the permanent magnet)×N+(the value in mechanical angle corresponding to one cycle in electrical angle of the permanent magnet)/2, where N represents a positive integer].

In this case, in cases where the first and second magnetic sensors are rotated in the circumferential direction relative to the ring body of the magnetic flux guiding ring under a state where the magnetic flux guiding ring and the permanent magnet are not relatively rotated, i.e., under a state where no or less fluctuation in the output from the magnetic detection unit can be expected since the pair of rotatable members are not relatively displaced; when the outputs of both the magnetic sensors are combined, the amplitude of the combined output waveform is lower than the amplitude of the output waveform of each magnetic sensor. Thus, the fluctuations in the output from the magnetic sensor portion which may cause erroneous detection can be reduced, resulting in improved detection accuracy.

In some exemplary embodiments of the relative rotational angular displacement detection device, the magnetic detection unit includes M pieces of facing portions in addition to the first facing portion and the second facing portion; and the facing portions are arranged at such positions that the angle formed between adjacent ones of the facing portions satisfies a relational expression of [(the value in mechanical angle corresponding to one cycle in electrical angle of the permanent magnet)×N+(the value in mechanical angle corresponding to one cycle in electrical angle of the permanent magnet)/(2+M), where N and M represent positive integers].

Also in this case, when the first and second magnetic sensors are rotated in the circumferential direction relative to the ring body of the magnetic flux guiding ring under a state where the magnetic flux guiding ring and the permanent magnet are not relatively rotated, i.e., under a state where no or less fluctuation in the output from the magnetic detection unit can be expected since the pair of rotatable members are not relatively displaced; when the outputs of both the magnetic sensors are combined, the amplitude of the combined output waveform is lower than the amplitude of the output waveform of each magnetic sensor. Thus, the fluctuations in the output from the magnetic sensor portion which may cause erroneous detection can be reduced, resulting in improved detection accuracy.

In some exemplary embodiments of the relative rotational angular displacement detection device, the magnetic detection unit includes a first intermediate yoke arranged between the first magnetic sensor and the ring body so as to face the ring body, and a second intermediate yoke arranged between the second magnetic sensor and the ring body so as to face the ring body. The first facing portion is provided at the first intermediate yoke, and the second facing portion is provided at the second intermediate yoke. Since the first intermediate yoke and the second intermediate yoke are provided, magnetic fluxes of the magnetic flux guiding ring can be collected, and the amplitude of magnetic fluxes that the ring body has directly received from the permanent magnet irrespective of the phase of the protruding portion can be averaged. This can further improve the accuracy of detection. Arranging each of the intermediate yokes between the corresponding magnetic sensor and the ring body allows, for example, the ring body to be arranged more outward with respect to the radial direction of the axis of rotation. This allows an increase in the inner diameter of the ring body, and a decrease in the size of the permanent magnet and the size of the distal end of each protruding portion. Thus, installation in the space is easy.

In some exemplary embodiments of the relative rotational angular displacement detection device, the first magnetic sensor is configured to detect magnetic fluxes that are received by the first facing portion provided at the first intermediate yoke, and the second magnetic sensor is configured to detect magnetic fluxes that are received by the second facing portion provided at the second intermediate yoke.

In some exemplary embodiments of the relative rotational angular displacement detection device, the magnetic detection unit includes a first intermediate yoke arranged between the first magnetic sensor and the ring body so as to face the ring body, and a second intermediate yoke arranged between the second magnetic sensor and the ring body so as to face the ring body. The first facing portion is provided at the first intermediate yoke, and the second facing portion is provided at the second intermediate yoke, and the first magnetic sensor is configured to detect magnetic fluxes of the first intermediate yoke, and the second magnetic sensor is configured to detect magnetic fluxes of the second intermediate yoke.

In some exemplary embodiments of the relative rotational angular displacement detection device, the first facing portion includes a first magnetic flux collecting portion for collecting and directing magnetic fluxes to the first magnetic sensor, and the second facing portion includes a second magnetic flux collecting portion for collecting and directing magnetic fluxes to the second magnetic sensor. That is, the first magnetic flux collecting portion may be formed to collect and direct, to direct or to draw and direct magnetic fluxes to the first magnetic sensor. The second magnetic flux collecting portion may be formed to collect and direct, to direct or to draw and direct magnetic fluxes to the second magnetic sensor. This enables magnetic fluxes to be efficiently collected to the magnetic sensors, thus achieving detection of a relative rotational angular displacement with a higher degree of accuracy. The first magnetic flux collecting portion and the second magnetic flux collecting portion are preferably recessed portions recessed in a radial direction of the axis of rotation. This achieves detection of a relative rotational angular displacement with a higher degree of accuracy.

In some exemplary embodiments of the relative rotational angular displacement detection device, the magnetic detection unit includes a first averaging part for averaging the amplitude of magnetic fluxes flowing toward the first magnetic sensor, and a second averaging part for averaging the amplitude of magnetic fluxes flowing toward the second magnetic sensor. The amplitude of magnetic fluxes flowing from the permanent magnet directly through the ring body to each of the first magnetic sensor and the second magnetic sensor irrespective of the phase of the protruding portion can be averaged. Accordingly, detection of a relative rotational angular displacement with a higher degree of accuracy is achieved.

According to other preferred embodiments of the present invention, a torque detection device is equipped with the relative rotational angular displacement detection device. The torque detection device includes an elastic member arranged between the pair of rotatable members, wherein a biasing force is constantly given to the pair of rotatable members by the elastic member in the relative rotational direction, and the pair of rotatable members are provided with a relative rotation restricting portion which restricts a relative rotation of the pair of rotatable members after one of the pair of rotatable members is rotated relative to the other of the pair of rotatable members by a certain rotational angle against the biasing force of the elastic member.

According to still other preferred embodiments of the present invention, a torque control device is equipped with the relative rotational angular displacement detection device. The torque control device includes a rotary driving member connected to one of the pair of rotatable members, wherein a rotational force is given to the rotary driving member by a user, a power source configured to give a rotational force to the other of the pair of rotatable members, and a control unit configured to control the rotational force given by the power source depending on an output of the magnetic detection unit in a state in which the one of the pair of rotatable members is rotated relative to the other of the pair of rotatable members by a certain rotational angle.

According to still other preferred embodiments of the present invention, a power assist wheelchair equipped with the torque control device can be provided.

According to still other preferred embodiments of the present invention, a power assist straddle-type vehicle equipped with the torque control device can be provided.

According to still other preferred embodiments of the present invention, a power steering device equipped with the torque control device can be provided.

According to some preferred embodiments of the present invention, the permanent magnet is attached to one of the pair of rotatable members in such a manner that magnetic poles are arranged so as to alternate in polarity in the circumferential direction of the axis of rotation, and the ring body of the magnetic flux guiding ring is attached to the other of the pair of rotatable members so that a plurality of protruding portions protruding from the ring body are arranged at positions facing the magnetic poles of the permanent magnet. Therefore, the protruding portion of the magnetic flux guiding ring can be formed into a simple shape, which in turn can form the protruding portion with a high degree of accuracy. Furthermore, since the protruding portions of the magnetic flux guiding ring are arranged at positions facing the magnetic poles in the magnetization direction of the permanent magnet, the relative position of the protruding portion relative to the permanent magnet can be determined only by the distance in the axial direction, which enables high-accuracy assembling. Therefore, although the relative rotational angular displacement detection device is simple in structure and simple in assembly, the relative rotational angular displacement of the pair of rotatable members which are relatively rotatable can be detected with a high degree of accuracy.

In the relative rotational angular displacement detection device, the magnetic fluxes of the ring body of the magnetic flux guiding ring magnetized depending on the relative position of each protruding portion of the magnetic flux guiding ring and each magnetic pole of the permanent magnet are detected by the magnetic detection unit. This reduces the number of component parts and simplifies the structure. Since the structure is simple, the production and assembly can also be performed easily with a high degree of accuracy.

The magnetic detection unit includes a first facing portion arranged to face a part of the ring body to guide magnetic fluxes of a part of the ring body, a second facing portion arranged at a position apart from the first facing portion in a circumferential direction of the axis of rotation to guide magnetic fluxes of a part of the ring body, a first magnetic sensor configured to detect the magnetic fluxes guided by the first facing portion, and a second magnetic sensor configured to detect the magnetic fluxes guided by the second facing portion. This reduces the number of component parts and simplifies the structure. Since the structure is simple, the production and assembly can also be performed easily with a high degree of accuracy.

Further, the first facing portion and the second facing portion are fixed in the circumferential direction of the axis of rotation regardless of rotation of the permanent magnet and the magnetic flux guiding ring about the axis of rotation. Therefore, the magnetic sensors can be arranged on a non-rotatable side such as a vehicle body, which simplifies the mounting structure and reduces the risk of malfunctions.

The configuration in which the first facing portion and the second facing portion are arranged at such positions that the central angle formed between the first facing portion and the second facing portion satisfies a relational expression of [(the value in mechanical angle corresponding to one cycle in electrical angle of the permanent magnet)×N+(the value in mechanical angle corresponding to one cycle in electrical angle of the permanent magnet)/2, where N represents a positive integer], or the configuration in which the magnetic detection unit includes M pieces of facing portions in addition to the first facing portion and the second facing portion and the facing portions are arranged at such positions that the angle formed between adjacent ones of the facing portions satisfies a relational expression of [(the value in mechanical angle corresponding to one cycle in electrical angle of the permanent magnet)×N+(the value in mechanical angle corresponding to one cycle in electrical angle of the permanent magnet)/(2+M), where N and M represent positive integers], achieves the following: in cases where the first and second magnetic sensors are rotated in the circumferential direction relative to the ring body of the magnetic flux guiding ring under a state where the magnetic flux guiding ring and the permanent magnet are not relatively rotated, i.e., under a state where no or less fluctuation in the output from the magnetic detection unit can be expected since the pair of rotatable members are not relatively displaced; when the outputs of both the magnetic sensors are combined, the amplitude of the combined output waveform is lower than the amplitude of the output waveform of each magnetic sensor. Thus, the fluctuations in the output from the magnetic sensor portion which may cause erroneous detection can be reduced, resulting in improved detection accuracy.

### BRIEF EXPLANATION OF THE DRAWINGS

The preferred embodiments of the present invention are shown by way of example, and not limitation, in the accompanying figures, in which:

FIG. 1 is an explanatory view showing a schematic structure of a relative rotational angular displacement detection device according to some exemplary embodiments of the present invention;

FIG. 2 is an enlarged cross-sectional view showing a portion “A” surrounded by a dash line in FIG. 1;

FIG. 3 is a schematic structural view of the aforementioned device as seen in an axial direction of the axis of rotation;

FIG. 4A is an explanatory view showing a positional relation of magnetic poles of the permanent magnet, protruding portions of the magnetic flux guiding ring, and the magnetic detection units;

FIG. 4B is a graph showing a waveform of an output of the first magnetic sensor, a waveform of an output of the second magnetic sensor, and a combined waveform obtained by combining these waveforms when the magnetic detection unit is rotated in the circumferential direction along the ring body of the magnetic flux guiding ring while maintaining the positional relation of the protruding portion and the magnetic detection unit to the state shown in FIG. 3;

FIG. 5A is an explanatory view showing a positional relation of the magnetic poles, the protruding portion of the magnetic flux guiding ring and the magnetic detection unit according to some exemplary embodiments of the present invention;

FIG. 5B a graph showing a waveform of an output of the first magnetic sensor, a waveform of an output of the second magnetic sensor, and a combined waveform obtained by combining these waveforms when the magnetic detection unit is rotated in the circumferential direction along the ring body of the magnetic flux guiding ring while maintaining the positional relation of the protruding portion and the magnetic detection unit to the initial state;

FIG. 6 is a plan view of an intermediate yoke used in some exemplary embodiments;

FIG. 7A is an explanatory view showing the positional relation of the magnetic poles and the protruding portions of the magnetic flux guiding ring in the initial state;

FIG. 7B is an explanatory view showing the positional relation of the magnetic poles and the protruding portions of the magnetic flux guiding ring in a state in which the first and second rotatable members are rotated by a certain angle from the initial state;

FIG. 8A is an explanatory view showing the magnetic flux distribution state of the magnetic poles and the protruding portions of the magnetic flux guiding ring in the initial state;

FIG. 8B is an explanatory view showing the magnetic flux distribution state of the permanent magnet, the magnetic flux guiding ring, the intermediate yoke, the magnetic sensor and the back yoke in the initial state;

FIG. 8C is an explanatory view showing the magnetic flux distribution state of the permanent magnet, the magnetic flux guiding ring, the intermediate yoke, the magnetic sensor and the back yoke and the vicinity thereof in the initial state;

FIG. 9A is an explanatory view showing the magnetic flux distribution state of the magnetic poles of the permanent magnet and the magnetic flux guiding ring in the state in which the first and second rotatable members are rotated by a certain angle from the initial state;

FIG. 9B is an explanatory view showing the magnetic flux distribution state of the permanent magnet, the magnetic flux guiding ring, the intermediate yoke, the magnetic sensor and the back yoke in the state in which the first and second rotatable members are rotated by a certain angle from the initial state;

FIG. 9C is an explanatory view showing the magnetic flux distribution state of the permanent magnet, the magnetic flux guiding ring, the intermediate yoke, the magnetic sensor and the back yoke and the vicinity thereof in the state in which the first and second rotatable members are rotated by a certain angle from the initial state;

FIG. 10 is an explanatory view showing a power assist wheelchair to which the torque control device including the relative rotational angular displacement detection device according to the present invention is applied;

FIG. 11 is an explanatory view showing a power assist bicycle to which the torque control device including the relative rotational angular displacement detection device according to the present invention is applied; and

FIG. 12 is a schematic explanatory view showing a power assist system in a vehicle power steering device to which the torque control device including the relative rotational angular displacement detection device according to the present invention is applied.

### DETAILED DESCRIPTION OF THE PREFERRED EMBODIMENTS

In the following paragraphs, some preferred embodiments of the present invention will be described with reference to the attached drawings by way of example and not limitation. It should be understood based on this disclosure that various other modifications can be made by those in the art based on these illustrated embodiments.

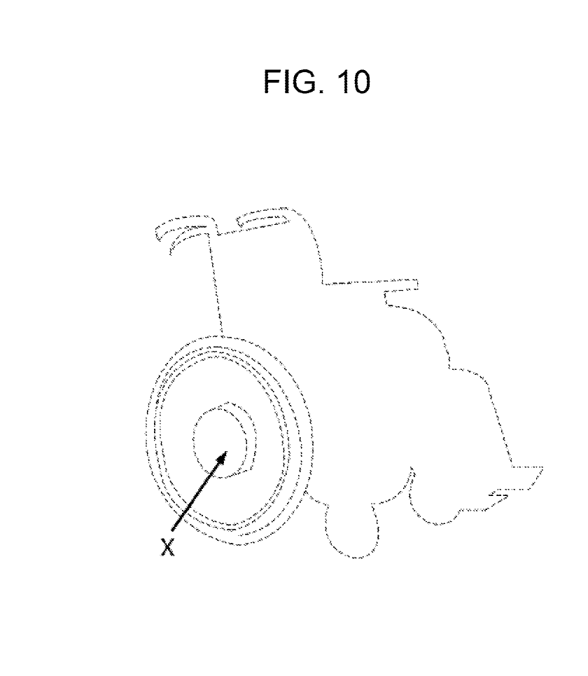

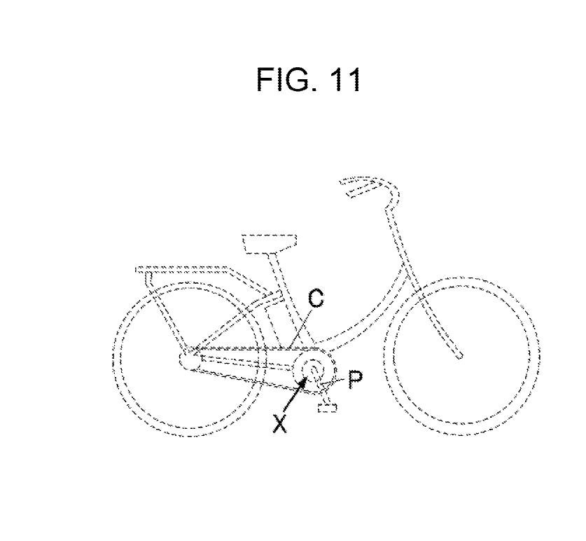

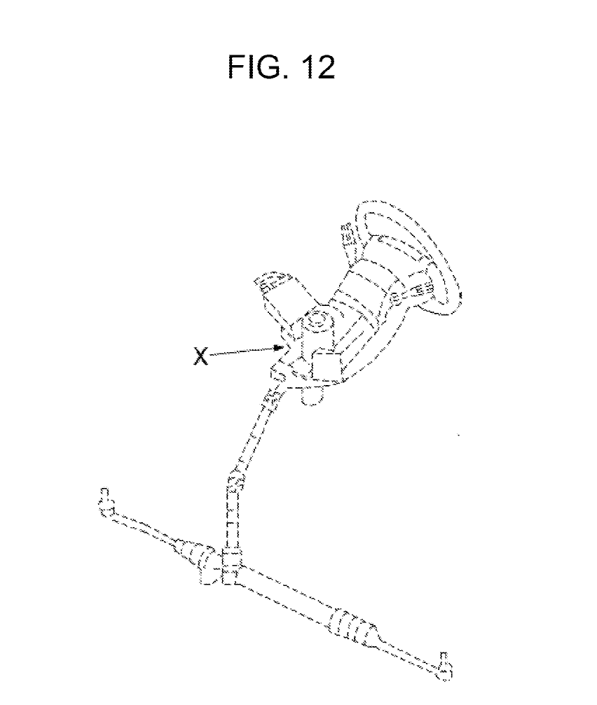

Hereinafter, an embodiment of the present invention in which a relative rotational angular displacement detection device X according to the present invention is applied to a power assist system for a power assist wheelchair (see FIG. 10) will be explained with reference to the attached drawings. Needless to say, the relative rotational angular displacement detection device according to the present invention is not limited to the case in which the device is used in a power assist system for a power assist wheelchair, and can also be applied to various devices and mechanisms for detecting a relative rotational angular displacement of a pair of rotatable members which are movable relatively. For example, the present invention can also be preferably applied to, e.g., a power assist system for a power assist bicycle (see FIG. 11), a power steering device for an automobile (see FIG. 12), etc.

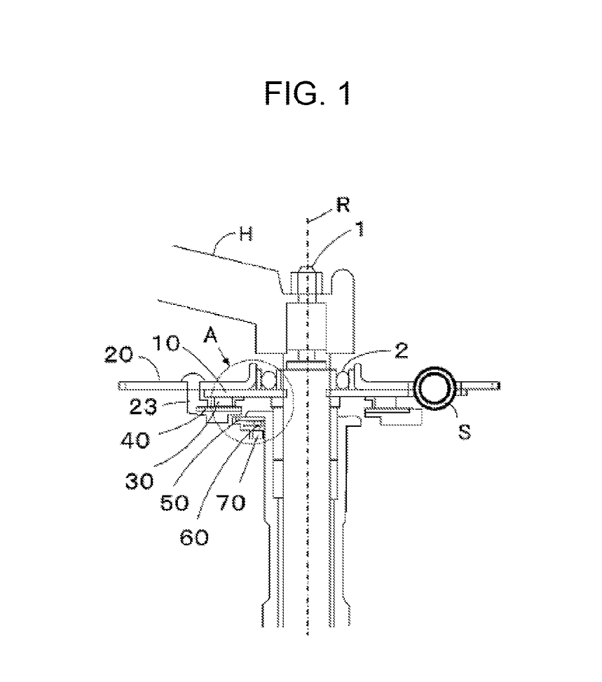

As shown in FIG. 1, in the relative rotational angular displacement device X according to the embodiment, a hand rim H is attached to one end of a shaft part 1. A lever member 10 as a first rotatable member and a gear 20 as a second rotatable member are arranged coaxially with the shaft part 1. As shown in this figure, the lever member 10 and the gear 20 are arranged close to each other in an adjacent manner so as to be relatively rotatable in the circumferential direction of an axis R of rotation.

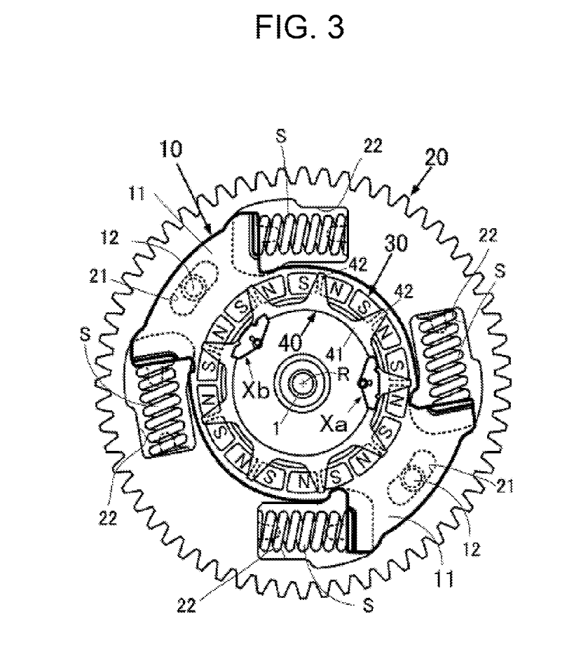

As shown in FIG. 3, the lever member 10 as a first rotatable member is integrally provided with two engaging portions 11 arranged at 180 degrees phase difference and each extending radially outward of the shaft part 1, and is configured to rotate together with the shaft part 1 along with the rotation of the hand rim H. On the other hand, as shown in FIG. 1, the gear 20 as a second rotatable member is arranged coaxially with the shaft part 1 via a bearing 2 in a rotatable manner relative to the lever member 10 as a first rotatable member.

As shown in FIG. 3, each engaging portion 11 of the lever member 10 is provided with an engaging projecting portion 12 protruded in an axially outward direction, i.e., protruded toward the gear 20. Each projecting portion 12 is fitted in an arc-shaped slit 21 formed in the gear 20, the slit 21 extending in the circumferential direction. This engaging projecting portion 12 is slidably movable within a range of the circumferential length of the slit 21 along with the rotational movement of the lever member 10.

In the gear 20, spring mounting holes 22 each for mounting a coil spring S as an elastic member are formed at four circumferential portions. In each spring mounting hole 22, a coil spring S is mounted. Each engaging portion 11 of the lever member 10 is arranged between a pair of coil springs S arranged in the circumferential direction and engaged with the end portions of the coil springs S. In this engaged state, each engaging portion 11 is biased by both the coil springs S in both directions, i.e., the clockwise direction and the counterclockwise direction.

Therefore, in a state in which no external force is applied, the lever member 10 remains stationary at a position where biasing forces of the pair of coil springs S are balanced. Thus, the lever member 10 is in a state in which the lever member 10 rotates in either clockwise direction or counterclockwise direction when a force is applied in the circumferential direction.

In a state in which no external force (rotational force) is applied, each engaging projecting portion 12 provided at each engaging portion 11 of the lever member 10 is positioned between one longitudinal end and the other longitudinal end of the corresponding slit 21 formed in the gear 20 as shown in FIG. 3. From this state, when a rotational force is applied to the hand rim H in a clockwise direction or in a counterclockwise direction, the shaft part 1 fixed to the hand rim H rotates. Along with the rotation of the hand rim H, the rotational force is given to the lever member 10 fixed to the shaft part 1, resulting in a rotation of the lever member 10 in the clockwise direction or in the counterclockwise direction.

When the lever member 10 rotates, the engaging portion 11 rotates relative to the gear 20 while pushing against the biasing force of the spring S that is located forward with respect to the rotation direction. At this time, the engaging projecting portion 12 provided at the engaging portion 11 of the lever member 10 moves in the circumferential direction (in the clockwise direction or in the counterclockwise direction) in the slit 21 formed in the gear 20. When the engaging projecting portion 12 provided at the engaging portion 11 of the lever member 10 reaches a circumferential end of the slit 21, the engaging projecting portion 12 is engaged with the circumferential end of the slit 21. Therefore, the gear 20 thereafter rotates together with the lever member 10 along with the rotation of the lever member 10. Even until the engaging projecting portion 12 reaches the circumferential end of the slit 21, the gear 20 rotates by the biasing force of the spring S.

As explained above, in this embodiment, the lever member 10 as a first rotatable member and the gear 20 as a second rotatable member are relatively movable within a certain range in the circumferential direction of the shaft part 1, i.e., within a range of the circumferential length of the slit 21 formed in the gear 20. By detecting the relative rotational angular displacement of the rotatable members 10 and 20 within the limited relative rotational range in the circumferential direction, in other words, the relative rotational torque, an electric motor (not illustrated) is controlled, so that a rotational force given from an outside and a rotational force of the electric motor outputted in accordance with the rotational force are combined to thereby control a rotational force of the gear 20.

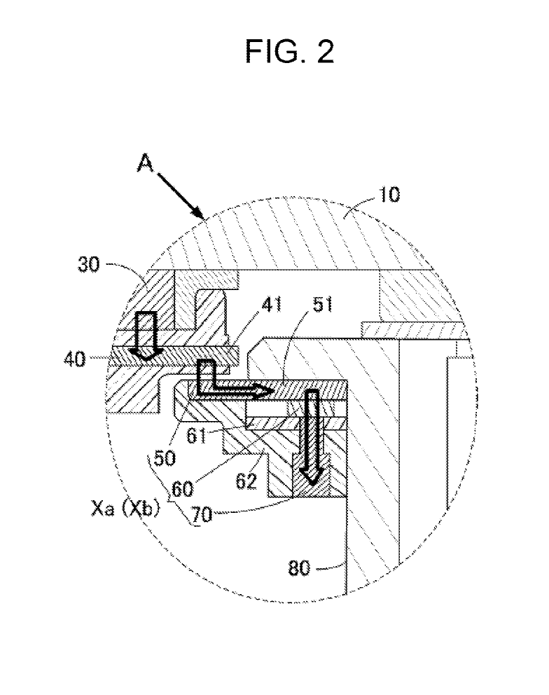

In order to detect the relative rotational angular displacement of the lever member 10 as a first rotatable member and the gear 20 as a second rotatable member, in this embodiment, as shown in FIG. 3, the device includes a permanent magnet 30, a magnetic flux guiding ring 40, and two magnetic sensing members (magnetic detection units) Xa and Xb. Each magnetic sensing member Xa and Xb includes, as main structural members, an intermediate yoke 50, a magnetic sensor 60 and a back yoke 70 as shown in FIG. 2.

The permanent magnet 30 is an annular or ring-shaped magnet arranged coaxially with the shaft part 1 as shown in FIG. 3, in which the magnetic poles, i.e., N-poles and S-poles, are arranged alternately in the circumferential direction of the shaft part 1. Each magnetic pole is magnetized in the axial direction of the shaft part 1, i.e., in a direction parallel to the axial direction of the axis R of rotation.

In this embodiment, nine pairs of magnetic poles (a total of 18 magnetic poles, nine S-poles and nine N-poles) are arranged at equal intervals in the circumferential direction. This annular or ring-shaped permanent magnet 30 is arranged coaxially with the lever member 10 and fixed to the lever member 10, so that the permanent magnet 30 rotates together with the rotation of the lever member 10. It should be noted, however, that in the present invention the permanent magnet 30 is not limited to the aforementioned annular or ring-shaped permanent magnet, but can be constituted by a plurality of separate permanent magnets arranged at equal intervals in the circumferential direction. Further, the permanent magnet 30 can be either a sintered magnet or a bond magnet, and also can be either an isotropic magnet or an anisotropic magnet. Further, the permanent magnet 30 can be a polar anisotropic magnet.

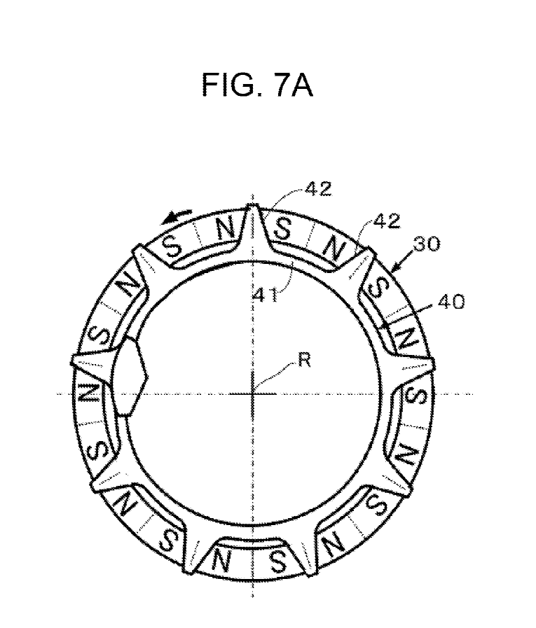

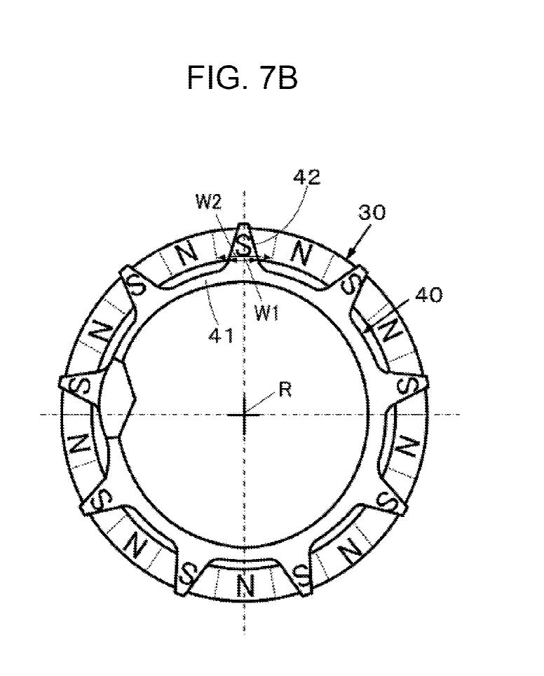

The magnetic flux guiding ring 40 is, as shown in FIGS. 1 to 3, arranged coaxially with the gear 20. The magnetic flux guiding ring 40 includes an annular ring body 41 and a plurality of protruding portions 42 protruded in a radially outward direction from the outer peripheral edge of the ring body 41. The ring body 41 is arranged so as not to overlap the permanent magnet 30 in the radial direction of the shaft part 1. In other words, the ring body 41 is arranged so as not to overlap the permanent magnet 30 when seen in the axial direction of the shaft part 1. The plurality of protruding portions 42 are arranged so as to overlap the permanent magnet 30 in the radial direction. In other words, the plurality of protruding portions 42 overlaps the permanent magnet 30 when seen in the axial direction of the shaft part 1. The number of protruding portions 42 (nine protruding portions in this embodiment) is equal to the number of pairs of magnetic poles of the permanent magnet 30. Each protruding portion 42 has a circumferential width W1 smaller than a circumferential width W2 of each magnetic pole as shown in FIG. 7B.

More specifically, each protruding portion 42 of the magnetic flux guiding ring 40 is formed into a tapered triangular shape or a trapezoidal shape with the width decreasing toward the radially outward direction. The circumferential width W1 of a portion of the protruding portion 42 overlapping the inner peripheral edge of the permanent magnet 30 when seen from the axial direction of the shaft part 1 is set to be narrower than the circumferential width W2 of the inner peripheral edge of each magnetic pole. As shown in FIG. 1, this magnetic flux guiding ring 40 is integrally secured to the gear 20 via an attachment 23 in a state in which the ring 40 is detached from the gear 20 in the axial direction. That is, the magnetic flux guiding ring 40 is configured to rotate together with the gear 20.

In this embodiment, it is exemplified that each protruding portion 42 of the magnetic flux guiding ring 40 extends in a radially outward direction. However, the protruding portion 42 of the magnetic flux guiding ring 40 is not limited to it. For example, the protruding portion 42 of the magnetic flux guiding ring 40 can be a protruding portion extending in a radially inward direction. That is, it can be configured such that the ring body 41 is arranged radially outward of the annular permanent magnet 30 and the protruding portions 42 extend from the ring body 41 in a radially inward direction.

The magnetic flux guiding ring 40 can be preferably produced by a stamping process being performed on a steel plate, etc., but the magnetic flux guiding ring 40 can be constituted by combining a plurality of members. Further, in this embodiment, it is exemplified that the magnetic flux guiding ring 40 includes the ring body 41 and protruding portions 42 that are formed on the same plane, but not limited to it. For example, the protruding portion 42 can be formed into a shape bent at a certain angle relative to the ring body 41.

Each protruding portion 42 of the magnetic flux guiding ring 40 is positioned in between the S-pole and the N-pole of the permanent magnet 30 in an initial state in which no external force is applied to the shaft part 1 as shown in FIG. 3. When an external force is applied to the shaft part 1 from the initial state, the lever member 10 rotates in either clockwise direction or counterclockwise direction in accordance with the direction of the external force. Along with the rotation, the lever member 10 is displaced relative to the gear 20.

At this time, the engaging projecting portion 12 provided at the engaging portion 11 of the lever member 10 moves along the slit 21 formed in the gear 20. The engaging projecting portion 12 of the lever member 10 moves along the slit 21 until the engaging projecting portion 12 is engaged with the circumferential end of the slit 21 and the further relative movement of the engaging projecting portion 12 is limited. In a state in which the engaging projecting portion 12 of the lever member 10 is moved and engaged with the circumferential end of the slit 21, all of the protruding portions 42 of the magnetic flux guiding ring 40 are positioned so that the area of the protruding portion 42 overlapping one of magnetic poles (e.g., S-pole) of the permanent magnet 30 becomes large.

The intermediate yoke 50 is arranged close to the magnetic flux guiding ring 40 via a certain gap so that the intermediate yoke 50 overlaps the ring body 41 of the magnetic flux guiding ring 40 in the radial direction of the shaft part 1, i.e., the intermediate yoke 50 overlaps the ring body 41 when seen in the axial direction of the shaft part 1. The intermediate yoke 50 is made of a ferromagnetic substance such as iron. The intermediate yoke 50 is provided for the purpose of collecting magnetic fluxes of the magnetic flux guiding ring 40 magnetized by the permanent magnet 30 and averaging the amplitude of the magnetic fluxes caused by rotation of the magnetic flux guiding ring 40.

The magnetic sensor 60 is an element for detecting the magnetic fluxes passing through the intermediate yoke 50 and is arranged to overlap the intermediate yoke 50 in the radial direction, i.e., arranged to overlap the intermediate yoke 50 when seen in the axial direction of the shaft part 1 as shown in FIGS. 1 and 2. As the magnetic sensor 60, for example, a Hall element (Hall IC) can be preferably used. As shown in FIG. 2, the magnetic sensor 60 may be attached to a resin base plate 61 and fixed to a vehicle side non-rotatable member 80 via a base plate holder 62.

The back yoke 70 is made of a ferromagnetic substance, such as, e.g., iron, and is integrally embedded in the base plate holder 62. This back yoke 70 is arranged close to the magnetic sensor 60 in a manner such that the back yoke 70 overlaps the magnetic sensor 60 in the radial direction, i.e., the back yoke 70 overlaps the magnetic sensor 60 when seen in the axial direction of the shaft part 1.

In detail, the intermediate yoke 50, the magnetic sensor 60, and the back yoke 70 are integrated so as to overlap with each other when seen in the axial direction of the shaft part 1, and constitute a magnetic flux collecting circuit that serves as a part of a magnetic flux circuit for the magnetic fluxes of the magnetic flux guiding ring 40 magnetized by the permanent magnet 30. Although the magnetic flux collecting circuit is formed by the intermediate yoke 50, the magnetic sensor 60, and the back yoke 70 as described above, such a configuration that the magnetic path for the magnetic fluxes of the permanent magnet 30 constitutes a magnetic closed loop circuit having a low magnetic resistance is not positively required.

In other words, it is constituted as if the magnetic circuit terminates at the back yoke 70. By employing such structure, it is possible to detect the changes of the magnetic fluxes passing between the intermediate yoke 50 and the back yoke 70 with no practical issues while simplifying the structure of the entire device. Needless to say, it may be likely that, for example, component parts of the vehicle such as the shaft part 1 happen to constitute a magnetic closed loop circuit.

Further, in this embodiment, as explained above, the intermediate yoke 50, the magnetic sensor 60 and the back yoke 70 are fixed to the vehicle side non-rotatable member 80, independently of the lever member 10 as a first rotatable member and the gear 20 as a second rotatable member. This further simplifies the mounting structure. Furthermore, the magnetic sensor side structure is non-rotatable, which causes less problems.

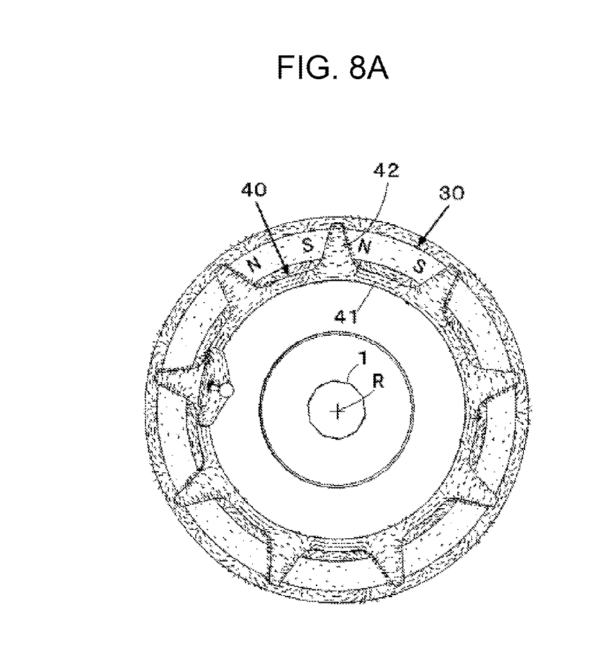

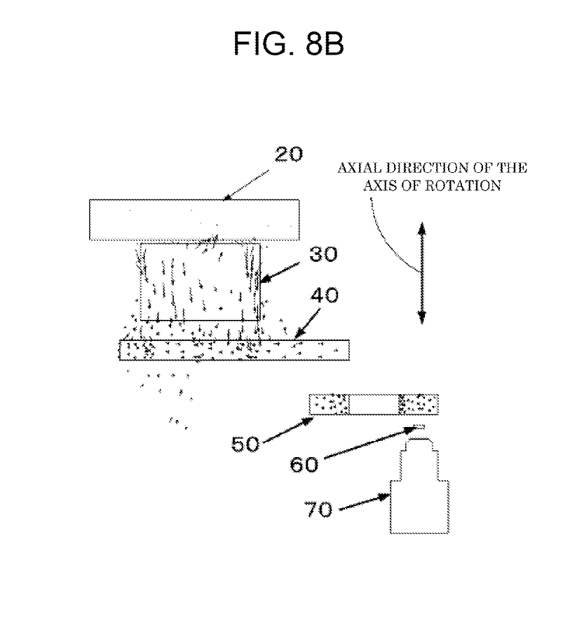

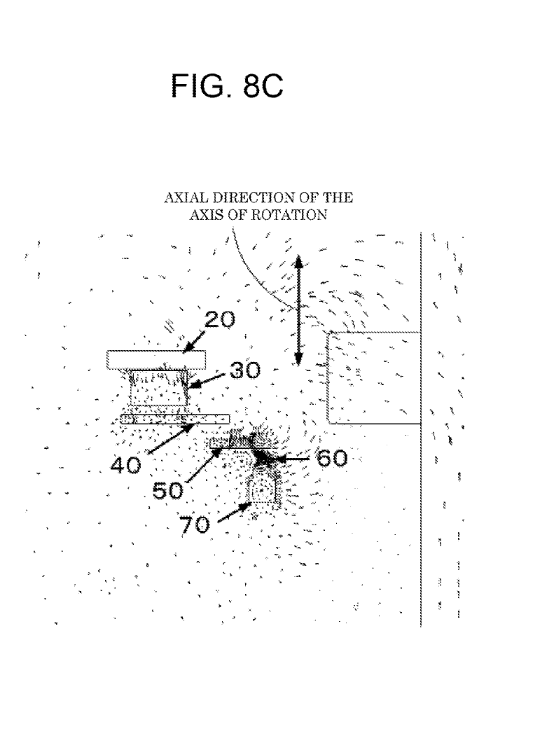

Next, the operating principle of the relative rotational angular displacement detection device of this embodiment will be explained with reference to FIGS. 7 to 9. In these figures, for the explanatory convenience, they illustrate a single magnetic sensing member (magnetic detection unit). FIG. 7A shows an initial state in which the lever member 10 as a first rotatable member and the gear 20 as a second rotatable member are not relatively rotated. In this initial state, each protruding portion 42 of the magnetic flux guiding ring 40 is positioned in between the adjacent magnetic poles of the permanent magnet 30, i.e., positioned between the N-pole and the S-pole. In this initial state, as shown in FIG. 8A, each protruding portion 42 constitutes a magnetic flux circuit of the adjacent N-pole and S-pole.

In the initial state, when seen in the axial direction of the shaft part 1, the ring body 41 is positioned such that each protruding portion 42 is positioned between the N-pole and the S-pole and that the overlapping area of the S-pole and the protruding portion 42 and the overlapping area of the N-pole and the protruding portion 42 are equal. Therefore, the ring body 41 is weakly magnetized to N-poles and S-poles of the permanent magnet 30 alternately in the circumferential direction. In other words, the ring body 41 is maintaining a so-called magnetically neutral state or almost neutral state (see FIG. 8A).

In the illustrative embodiment, the outer peripheral edge of the ring body 41 and the inner peripheral edge of the permanent magnet 30 are set to have a narrow gap therebetween. Therefore, as explained above, although the ring body 41 is weakly magnetized to N-poles and the S-poles alternately in the circumferential direction corresponding to the N-poles and the S-poles of the permanent magnet 30 or almost not magnetized, by increasing the gap, the magnetization state of the ring body 41 becomes further weak, which results in further improved detection accuracy.

Accordingly, in this initial state, the magnetic fluxes flowing from the ring body 41 of the magnetic flux guiding ring 40 to the intermediate yoke 50 are very weak, or almost no magnetic flux exists between the magnetic flux guiding ring 40 and the intermediate yoke 50 (see FIGS. 8B and 8C). In this initial state, the magnetic fluxes of the ring body 41 of the magnetic flux guiding ring 40 weakly magnetized to N-poles and S-poles alternately in the circumferential direction are collected by the intermediate yoke 50 and the back yoke 70 which are arranged adjacent to the ring body 41 of the magnetic flux guiding ring 40 and intensively flows through the magnetic sensor 60 arranged between the intermediate yoke 50 and the back yoke 70 (see FIG. 8C). Accordingly, the magnetic sensor 60 can assuredly detect the magnetic fluxes of the ring body 41 of the magnetic flux guiding ring 40.

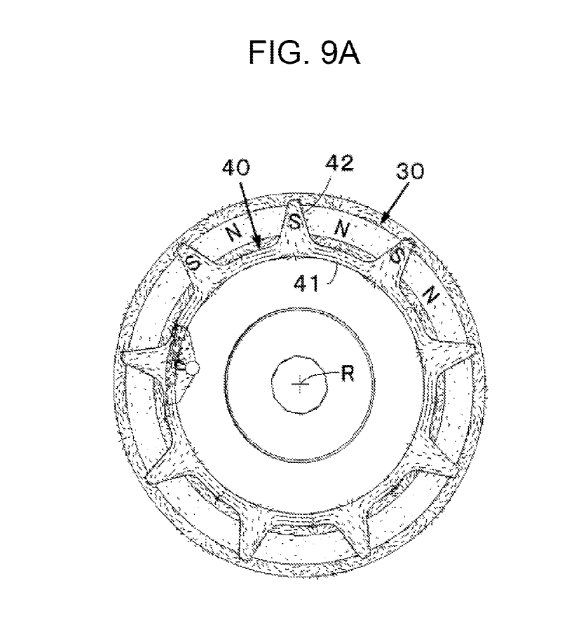

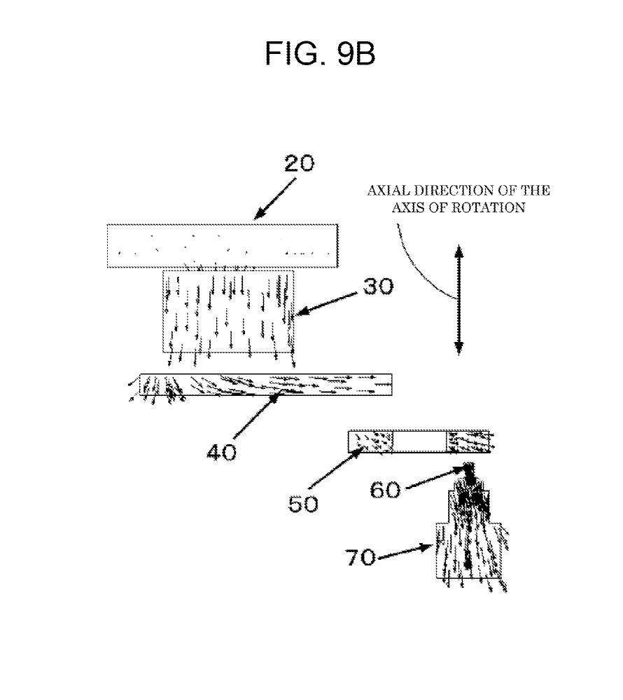

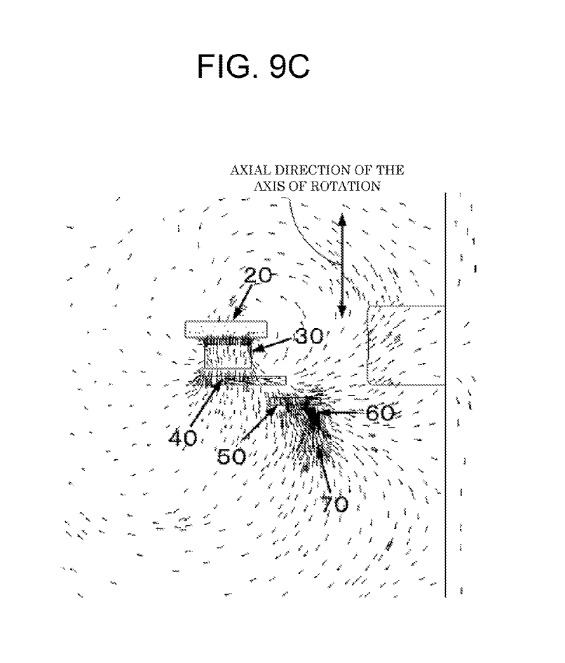

On the other hand, from the aforementioned initial state, when the lever member 10 rotates by a certain angle (10 degrees in this embodiment) in the circumferential direction and each protruding portion 42 of the magnetic flux guiding ring 40 overlaps one of magnetic poles (S-pole in this embodiment) of the permanent magnet 30 when seen in the axial direction, the protruding portion 42 is strongly magnetized to the overlapping magnetic pole (S-pole in this embodiment) (see FIG. 9A). As a result, the ring body 41 of the magnetic flux guiding ring 40 is magnetized to the overlapping magnetic pole (S-pole in this embodiment) of the permanent magnet 30 along the entire circumference.

Accordingly, the magnetic fluxes of the magnetic flux guiding ring 40 magnetized as mentioned above are collected by the intermediate yoke 50 and the back yoke 70 which are arranged adjacent to the magnetic flux guiding ring 40 and intensively flows through the magnetic sensor 60 arranged between the intermediate yoke 50 and the back yoke 70 (see FIGS. 9B and 9C). As a result, the magnetic sensor 60 can assuredly detect the magnetic fluxes of the ring body 41 of the magnetic flux guiding ring 40 magnetized to one of magnetic poles (S-pole in this embodiment) in the circumferential direction.

As will be understood from the above, by forming the magnetic flux collecting circuit only by the intermediate yoke 50 and the back yoke 70, without positively forming a magnetic closed loop circuit, the displacement of the magnetic fluxes passing through the magnetic flux collecting circuit can be detected by the magnetic sensor 60 in a practically satisfactory manner. As shown in FIGS. 8C and 9C, also in this device, although the permanent magnet 30 forms a magnetic closed loop circuit via the magnetic flux guiding ring 40, the intermediate yoke 50 and the back yoke 70, it is not always required to positively form a magnetic closed loop circuit using members other than the aforementioned members.

The phrase “it is not always required to positively form a magnetic closed loop circuit” means that it is sufficient to positively form a magnetic flux collecting circuit by at least the magnetic flux guiding ring 40, the intermediate yoke 50 and the back yoke 70. In other words, in the present invention, it is not intended to exclude the case in which other vehicle constitutional members, such as, e.g., a shaft part 1 or peripheral members thereof, eventually form a magnetic closed loop circuit together with the magnetic flux guiding ring 40, the intermediate yoke 50, and the back yoke 70. It should be understood that the present invention does not always require to positively form a magnetic closed loop circuit.

When the permanent magnet 30 rotates in the counterclockwise direction relative to the magnetic flux guiding ring 40 from the state in which the protruding portion 42 of the magnetic flux guiding ring 40 is positioned between the S-pole and the N-pole of the permanent magnet 30, the magnetization state of the ring body 41 of the magnetic flux guiding ring 40 gradually changes from the so-called magnetically neutral or almost neutral state in which the ring body 41 of the magnetic flux guiding ring 40 is weakly magnetized along the entire circumference to the state in which the entire ring body 41 is magnetized to the S-pole. The magnetic sensor 60 detects the change of the magnetic fluxes depending on the relative rotational angular displacement of the magnetic flux guiding ring 40 relative to the permanent magnet 30.

Therefore, depending on the change of the detected magnetic fluxes, the relative rotational angular displacement is continuously detected. In this embodiment, since the spring S is mounted, the relative rotational angular displacement of the lever member 10 and the gear 20 can be detected, which in turn can detect the relative rotational torque displacement. Therefore, by controlling a power driving means (not illustrated) with a controller (not illustrated) based on the displacement, the rotational force of the shaft part 1 can be assisted.

As explained above, the magnetization state of the ring body 41 of the magnetic flux guiding ring 40 caused by the magnetic poles of the permanent magnet 30 due to the relative rotational angular displacement of the rotatable members 10 and 20 is detected by the magnetic sensor 60, which in turn can detect the relative rotational angular displacement of the pair of rotational members. In order to perform the detection with a higher degree of accuracy, in the relative rotational angular displacement device according to this embodiment of the present invention, as shown in FIG. 3, the device is provided with two magnetic sensing members Xa and Xb each including the intermediate yoke 50, the magnetic sensor 60 and the back yoke 70.

The reasons for providing two magnetic sensing members Xa and Xb are as follows. That is, in the initial state shown in FIG. 3, i.e., in the state in which the protruding portion 42 of the magnetic flux guiding ring 40 is positioned between the S-pole and the N-pole, as mentioned above, the ring body 41 of the magnetic flux guiding ring 40 is maintaining the state in which the ring body 41 is weakly magnetized alternately in the circumference direction corresponding to the S-pole and the N-pole of the permanent magnet 30. In other words, in the initial state, the ring body 41 is maintaining a so-called magnetically neutral state. However, the ring body 41 is not completely magnetically neutral, but is slightly magnetized so as to alternate in polarity in the circumferential direction by the influence of each magnetic pole of the permanent magnet 30. Furthermore, it is designed that the permanent magnet 30 and the magnetic flux guiding ring 40 are arranged coaxially with each other. In an actual product, however, there is a case in which the permanent magnet 30 and the magnetic flux guiding ring 40 are not arranged completely coaxially with each other but slightly shifted with each other. In such a case, the gap between the inner peripheral edge of the permanent magnet 30 and the outer peripheral edge of the ring body 41 of the magnetic flux guiding ring 40 slightly differs in the circumferential direction. Furthermore, there is a possibility that the magnetization state of the permanent magnet 30 is not always as designed.

Accordingly, when the magnetic sensing member is moved relative to the ring body 41 of the magnetic flux guiding ring 40 in the circumferential direction in a state in which the relative position of the pair of rotatable members are maintained (e.g., in the initial state), the output of the magnetic sensor 60 may sometimes fluctuate. In this case, since the pair of rotatable members are not relatively rotated, such fluctuations in the output are not preferable.

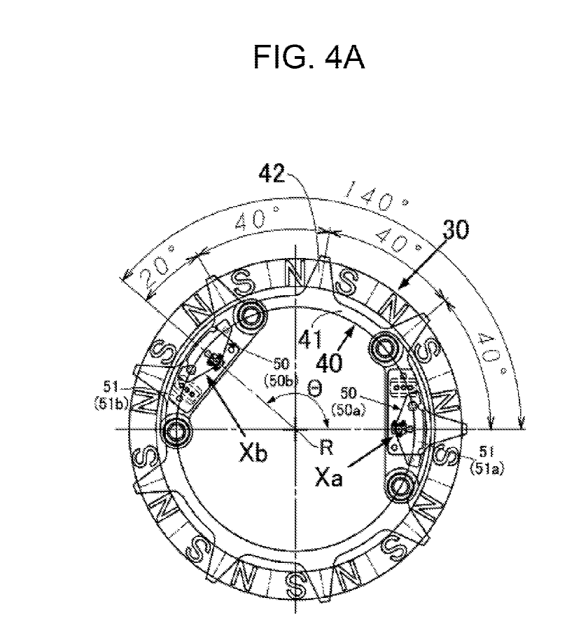

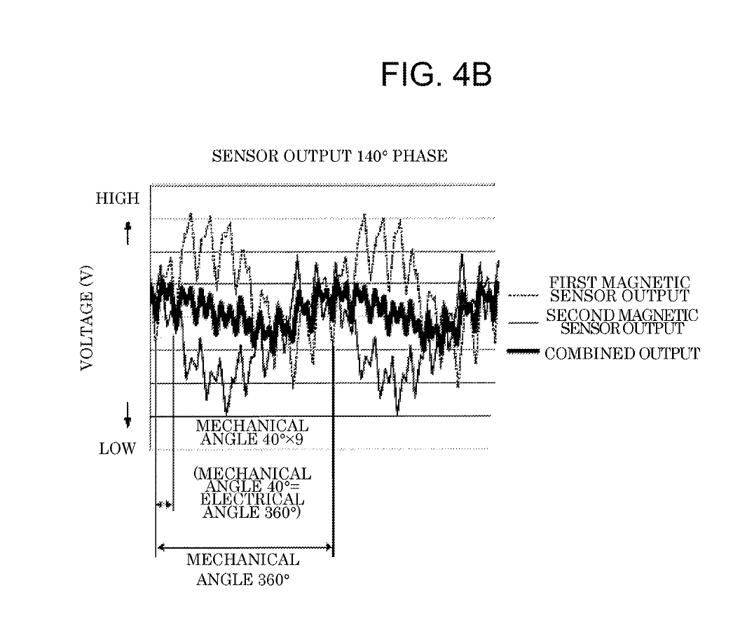

Although it is, of course, possible to control the fluctuations in the output of the magnetic sensor 60 by software, etc., the present invention solves the aforementioned problem by mechanical structure. FIG. 4B shows output waveforms of the magnetic sensor. As apparent from this graph, the output of the magnetic sensor fluctuates largely and periodically with small fluctuations. The small fluctuations are caused by the ring body 41 of the magnetic flux guiding ring 40 slightly magnetized so as to change in polarity in the circumferential direction. On the other hand, it is thought that the large fluctuations are caused by mechanical errors, such as, e.g., the misalignment of the permanent magnet 30 and the ring body 41 of the magnetic flux guiding ring 40.

Accordingly, in the device of the some exemplary embodiments, as shown in FIG. 3, two magnetic sensing members Xa and Xb constituted by the intermediate yoke 50, the magnetic sensor 60 and the back yoke 70 are prepared and arranged so as to satisfy the positional relation capable of suppressing the amplitude of the waveform of the combined output of the magnetic sensors 60.

Specifically, in the some exemplary embodiments, as shown in FIG. 4A, two magnetic sensing members Xa and Xb are arranged so that the output of one of the magnetic sensing members Xa and Xb and the output of the other of the magnetic sensing members Xa and Xb are opposite in phase. More specifically, two magnetic sensing members Xa and Xb are arranged at positions different in phase by 140 degrees of mechanical angle. One cycle (360°) in electrical angle corresponds to, in mechanical angle, the entire circumferential width of one pair of magnetic poles. In the case illustrated in this embodiment, one cycle in electrical angle corresponds to 40 degrees in mechanical angle. Therefore, the two magnetic sensing members Xa and Xb are arranged at positions that satisfy a relation of [40 degrees (the value in mechanical angle corresponding to one cycle in electrical angle)×3+20 degrees ((the value in mechanical angle corresponding to one cycle in electrical angle)/2)]. It suffices that the two magnetic sensing members Xa and Xb are arranged at positions that satisfy a relation of [(the value in mechanical angle corresponding to one cycle in electrical angle)×N+(the value in mechanical angle corresponding to one cycle in electrical angle)/2, where N represents a positive integer]. Preferably, the central angle formed between the two magnetic sensing members Xa and Xb (a first facing portion 51a and a second facing portion 51b) is 90° or more in mechanical angle and 270° or less in mechanical angle, as illustrated in this embodiment. That is, it is preferable that the central angle is not an included angle. This enables detection of a relative rotational angular displacement with a high degree of accuracy.

In the embodiment in which two magnetic sensing members Xa and Xb are arranged at the positions shown in FIG. 4A, it is understood from FIG. 4B that the waveform of the combined output obtained by combining the outputs of two magnetic sensors is suppressed in amplitude approximately in halves as compared with the waveform of the output of each magnetic sensing member.

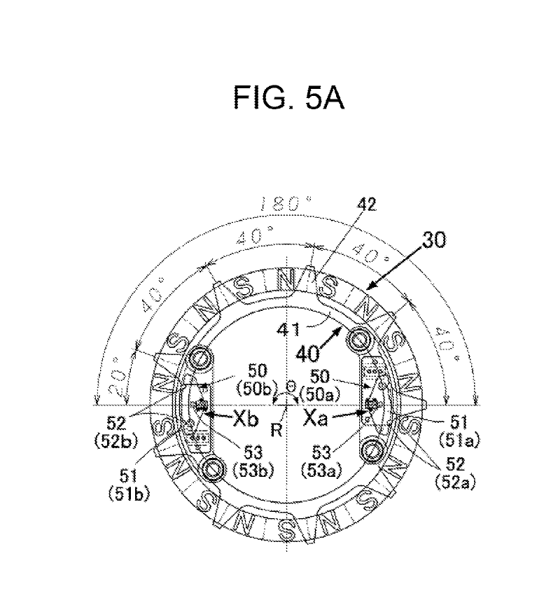

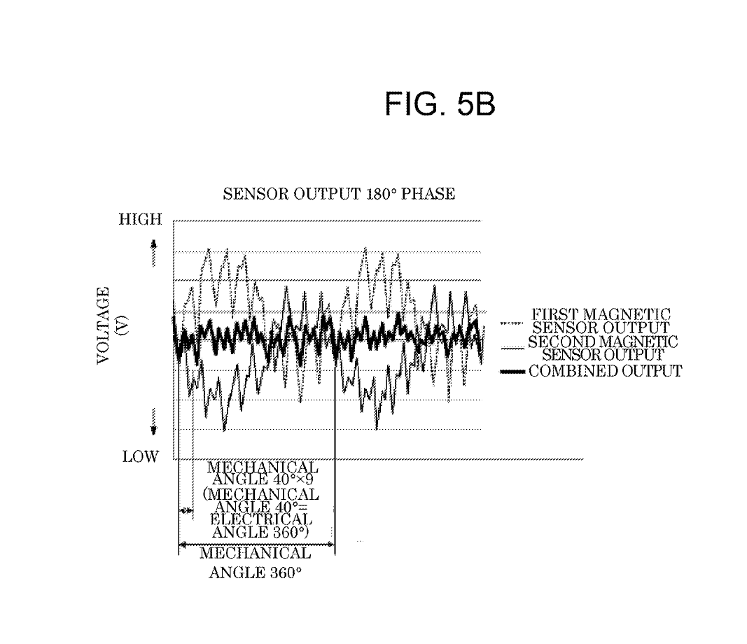

FIG. 5A shows some exemplary embodiments according to the present invention. In this embodiment, two magnetic sensing members Xa and Xb are arranged at a phase difference of 180 degrees. In this case as well, the relation of [(the value in mechanical angle corresponding to one cycle in electrical angle)×N+(the value in mechanical angle corresponding to one cycle in electrical angle)/2] is satisfied. The combined output waveform obtained by combining the outputs of the two magnetic sensors has a lower amplitude than the amplitude of the output waveform of each magnetic sensor alone (see FIG. 5B). Since the other structure is the same as that of the embodiment described in FIG. 4A, the detail explanation will be omitted.

It can be configured such that the magnetic detection unit X includes M pieces of facing portions in addition to the first facing portion 51a and the second facing portion 51b. In such a case, the facing portions are arranged such that the angle formed between adjacent ones of the facing portions with respect to the circumferential direction of the axis R of rotation satisfies a relational expression of [(the value in mechanical angle corresponding to one cycle in electrical angle of the permanent magnet)×N+(the value in mechanical angle corresponding to one cycle in electrical angle of the permanent magnet)/(2+M), where N and M represent positive integers and N may be a different value from the previously described N above with respect to the two magnetic sensing members Xa and Xb]. With this, the same effects as mentioned above can be exerted. It is also understood that if there are an M number of total pieces of facing portions (including the first and second facing portions 51a, 51b), the following relational expression may be satisfied [(the value of the mechanical angle corresponding to one cycle of the electrical angle of the permanent magnet)×N+(the value of the mechanical angle corresponding to the one cycle in electrical angle of the permanent magnet)/(M), where N represents a positive integer and M is a total number of the facing portions].

In the above exemplary embodiments, two magnetic sensing members Xa and Xb are arranged. However, the present invention is not limited to these embodiments. For example, the number of magnetic sensing members and the positions thereof are not limited as long as a plurality of magnetic sensing members are arranged so as to satisfy the positional relation capable of suppressing the amplitude of the waveform of the combined output of the plurality of magnetic sensors as compared to the amplitude of the waveform of the output of each magnetic sensor, when a plurality of magnetic sensing members are moved in the circumferential direction relative to the ring body of the magnetic flux guiding ring in a state in which each protruding portion of the magnetic flux guiding ring is arranged between the S-pole and the N-pole of the permanent magnet.

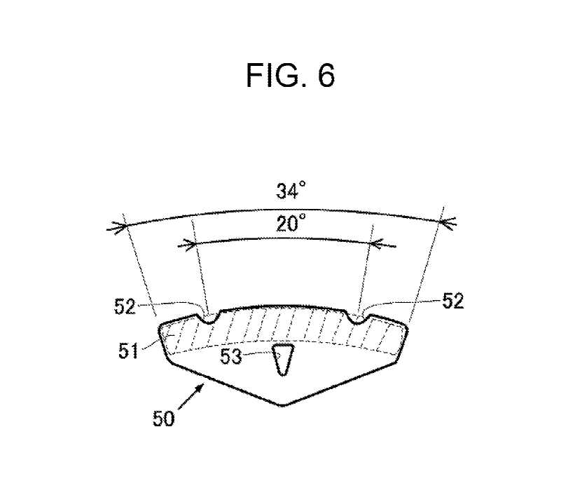

FIG. 6 is a plan view showing an intermediate yoke 50 used in each embodiment. This intermediate yoke 50 is formed into a generally fan-shape including a facing portion 51 which overlaps the ring body 41 of the magnetic flux guiding ring 40 when seen in the axial direction of the shaft part 1. The intermediate yoke 50 further includes a pair of cutout portions 52 and 52 formed in the outer peripheral edge of the outer peripheral edge portion so as to separate in the circumferential direction. The positions of the pair of cutout portions 52 correspond to half (20 degrees) of the value in mechanical angle (in the embodiment, 40 degrees) corresponding to one cycle in electrical angle of the permanent magnet 30. The cutout portion 52 is an illustrative example of a recessed portion which is formed by cutting out the intermediate yoke 50 in the radial direction of the axis of rotation. That is, the facing portion 51 may include a recessed portion recessed toward the inside with respect to the radial direction of the axis of rotation. The recessed portions (for example, the cutout portions 52) formed in the first facing portion correspond to a first magnetic flux collecting portion which collects and directs magnetic fluxes toward a first magnetic sensor. The recessed portions formed in the second facing portion correspond to a second magnetic flux collecting portion which collects and directs magnetic fluxes toward a second magnetic sensor. The magnetic sensor is positioned substantially between the pair of magnetic flux collecting portions. The intermediate yoke 50 also includes an opening portion 53. The opening portion 53 is provided at a position that does not overlap the ring body 41 of the magnetic flux guiding ring 40 when seen in the axial direction of the shaft part 1. The opening portion 53 is provided at a position that does not overlap the facing portion 51 when seen in the axial direction of the shaft part 1. The opening portion 53 is provided at a substantially intermediate position with respect to the circumferential direction of the intermediate yoke 50. As shown in FIG. 6, the opening portion 53 is substantially in the shape of an inverted triangle. The opening portion 53 is an illustrative example of an averaging part. The averaging part (opening portion 53) is positioned between the permanent magnet 30 and the magnetic sensor 60 with respect to the radial direction. The averaging part (opening portion 53) is positioned between the facing portion 51 and the magnetic sensor 60 with respect to the radial direction. The averaging part (opening portion 53) and the magnetic sensor 60 are located on a straight line extending in the radial direction. The averaging part (opening portion 53) is configured to average the amplitude of magnetic fluxes flowing from the facing portion 51 to the magnetic sensor 60. In the facing portion 51 (51a, 51b), magnetic fluxes coming from the ring body 41 are, at the cutout portions 52 (magnetic flux collecting portion), collected toward the magnetic sensor 60. Then, the amplitude of the magnetic fluxes flowing from the facing portion 51 toward the magnetic sensor 60 is averaged by the opening portion 53 (averaging part). The magnetic fluxes having the averaged amplitude are detected by the magnetic sensor 60.

Examples of concrete dimensions of each portion of the intermediate yoke 50 are shown in FIG. 6. The reasons for employing the illustrated shape are to reduce the influence of the ring body 41 of the magnetic flux guiding ring 40 magnetized so as to alternate in polarity in the circumferential direction, i.e., to reduce the minor fluctuations of the output waveform of each magnetic sensor 60 shown in FIGS. 4B and 5B. Accordingly, as mentioned above, by using two or more magnetic sensing members and the intermediate yoke 50 having the shape shown in FIG. 6, the fluctuations of the output waveform of the magnetic sensor which do not contribute to the rotational angular displacement detection can be reduced, which in turn can improve the detection accuracy.

As explained above, in some embodiments, it is configured such that the lever member 10 as a first rotatable member is rotationally displaced in both directions, i.e., the counterclockwise direction and the clockwise direction, relative to the gear 20 as a second rotatable member. Therefore, the direction of the magnetic fluxes passing through the magnetic sensor 60 changes depending on the direction of the relative rotational angular displacement of both the rotatable members. Therefore, when an electric motor (not illustrated) as an auxiliary power source is controlled using the output of the magnetic sensor 60 via a control circuit (not illustrated), in a power assist wheelchair for example, not only the forward driving but also the reverse driving can be assisted.

Further, in the aforementioned embodiments, the case in which a coil spring S is used as an elastic member is exemplified. It should be noted, however, that various springs can be utilized and it can be configured to detect the relative rotational angular displacement or the rotational torque of the first and second rotatable members using other elastic member of various resin or metal, e.g., a torsional dumper, etc. Further, as a permanent magnet, the present invention may use cylindrical permanent magnet.

According to some embodiments of the present invention, the relative rotational angular displacement detection device includes the permanent magnet 30, the magnetic flux guiding ring 40, the intermediate yoke 50, the magnetic sensor 60, and the back yoke 70. The permanent magnet 30 is fixed to one of the pair of rotatable members 10 and 20 and includes S-poles and N-poles magnetized in the axial direction of the shaft part 1 and arranged alternately in the circumferential direction of the shaft part 1.

The magnetic flux guiding ring 40 includes an annular ring body 41 fixed to the other of the pair of rotatable members 10 and 20 and arranged so as not to overlap the permanent magnet 30 when seen in the axial direction of the shaft part 1, and a plurality of protruding portions 42 protruded from the ring body 41 in a radially outward direction of the shaft part 1 and arranged so as to overlap the permanent magnet 30 when seen in the axial direction of the shaft part 1.

The intermediate yoke 50 is arranged close to the ring body 41 of the magnetic flux guiding ring 40, and the back yoke 70 constitutes a magnetic flux collecting circuit together with the intermediate yoke 50. The magnetic sensor 60 is arranged between the intermediate yoke 50 and the back yoke 70.

Therefore, the relative rotational angular displacement detection device can assuredly detect the relative rotational angular displacement of the first rotatable member 10 and the second rotatable member 20 with a simple structure. Further, the relative rotational angular displacement detection device is configured to detect the magnetic fluxes passing through the magnetic flux collecting path constituted by the intermediate yoke 50 and the back yoke 70 with the magnetic sensor 60 without positively forming a magnetic closed loop of the permanent magnet 30. This further simplifies the structure, the production and the assembly of the device, which in turn can reduce the cost.

Furthermore, the magnetic sensors are arranged so as to satisfy such a positional relation that, when the magnetic sensing members are rotationally moved in the circumference direction relative to the ring body of the magnetic flux guiding ring under the state where the relative positions of the permanent magnet and the magnetic flux guiding ring relative to each other are maintained, the amplitude of the output waveform obtained by combining the outputs of the magnetic sensors is lower than the amplitude of the output waveform of each magnetic sensor. Therefore, the output waveform obtained by combining the outputs of both the magnetic sensors is flattened, which can reduce the risk of occurrence of erroneous detections. Thus, the detection accuracy can be improved.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.”

The present invention can be preferably applied to a relative rotational angular displacement detection device for use in a power assist system for, e.g., a power assist wheelchair, a power assist bicycle, a power steering wheel, etc., to detect a relative rotational angular displacement of a pair of rotatable members relatively rotatable in the circumferential direction of a rotation shaft. The present invention can also be preferably applied to a torque detection device or a torque control device including the detection device.

1. A relative rotational angular displacement detection device, comprising:
a pair of rotatable members rotatable by 360 degrees about an axis of rotation, the rotatable members being rotatable relative to each other about the axis of rotation in a circumferential direction thereof;
a permanent magnet attached to one of the pair of rotatable members so as to rotate with the one rotatable member, the permanent magnet including magnetic poles arranged so as to alternate in polarity in the circumferential direction of the axis of rotation;
a magnetic flux guiding ring including
a plurality of protruding portions arranged at positions facing the magnetic poles,
an annular ring body attached to the other of the pair of rotatable members so as to rotate with the other rotatable member, the annular ring body arranged coaxially with the axis of rotation, the annular ring body magnetized with a strength of magnetization changing depending on the positions of the protruding portions relative to positions of the magnetic poles; and
a magnetic detection unit configured to detect magnetic fluxes of the ring body, the magnetic detection unit including
a first facing portion arranged to face a first part of the ring body and configured to receive magnetic fluxes of the first part of the ring body,
a second facing portion arranged at a position apart from the first facing portion with respect to the circumferential direction, the second facing portion configured to receive magnetic fluxes of a second part of the ring body,
a first magnetic sensor configured to detect the magnetic fluxes received by the first facing portion, and
a second magnetic sensor configured to detect the magnetic fluxes received by the second facing portion,
the first facing portion and the second facing portion configured such that their relative positions with respect to the circumferential direction of the axis of rotation are fixed independently of rotation of the permanent magnet and the magnetic flux guiding ring about the axis of rotation,
the first facing portion and the second facing portion are arranged at the positions such that a central angle formed between the first facing portion and the second facing portion satisfies a relational expression of:
(a value of a mechanical angle that corresponds to one cycle of an electrical angle of the permanent magnet)×N+(the value of the mechanical angle corresponding to the one cycle of the electrical angle of the permanent magnet)/2,
where N represents a positive integer.

2. The relative rotational angular displacement detection device as recited in claim 1, wherein
the magnetic detection unit includes M pieces of facing portions in addition to the first facing portion and the second facing portion,
the facing portions are arranged at such positions that an angle formed between adjacent ones of the facing portions satisfies a relational expression of:
(the value of the mechanical angle corresponding to the one cycle of the electrical angle of the permanent magnet)×N+(the value of the mechanical angle corresponding to the one cycle in electrical angle of the permanent magnet)/(2+M),
where N and M represent positive integers.

3. The relative rotational angular displacement detection device as recited in claim 1, wherein the magnetic detection unit includes
a first intermediate yoke arranged between the first magnetic sensor and the ring body so as to face the ring body, and
a second intermediate yoke arranged between the second magnetic sensor and the ring body so as to face the ring body,
the first facing portion is provided at the first intermediate yoke,
the second facing portion is provided at the second intermediate yoke,
the first magnetic sensor is configured to detect magnetic fluxes that are received by the first facing portion provided at the first intermediate yoke,
the second magnetic sensor is configured to detect magnetic fluxes that are received by the second facing portion provided at the second intermediate yoke.

4. The relative rotational angular displacement detection device as recited in claim 1, wherein
the first facing portion includes a first magnetic flux collecting portion for collecting and directing, directing, or drawing and directing magnetic fluxes to the first magnetic sensor,
the second facing portion includes a second magnetic flux collecting portion for collecting and directing, directing, or drawing and directing magnetic fluxes to the second magnetic sensor.

5. The relative rotational angular displacement detection device as recited in claim 4, wherein the first magnetic flux collecting portion and the second magnetic flux collecting portion are recessed portions that are each recessed in a radial direction radiating from the axis of rotation.

6. The relative rotational angular displacement detection device as recited in claim 1, wherein the magnetic detection unit includes a first averaging part for averaging amplitudes of magnetic fluxes flowing toward the first magnetic sensor, and a second averaging part for averaging amplitudes of magnetic fluxes flowing toward the second magnetic sensor.

7. The relative rotational angular displacement detection device as recited in claim 1, wherein the magnetic detection unit is configured to detect magnetic fluxes of the ring body based on the magnetic fluxes detected by the first magnetic sensor and the magnetic fluxes detected by the second magnetic sensor.

8. A torque detection device comprising:
the relative rotational angular displacement detection device as recited in claim 1; and
an elastic member arranged between the pair of rotatable members, the elastic member configured to constantly give a biasing force in a relative rotation direction to the pair of rotatable members, wherein
the pair of rotatable members are provided with a relative rotation restriction part,
the relative rotation restriction part is configured to prevent rotation of the rotatable members relative to each other after a first of the pair of rotatable members is rotated relative to a second of the rotatable members through a predetermined rotational angle against the biasing force of the elastic member.

9. A torque control device comprising:
the relative rotational angular displacement detection device as recited in claim 1;
a rotary driving member connected to a first of the pair of rotatable members, the rotary driving member being given a rotational force by a user;
a power source configured to give a rotational force to a second of the rotatable members; and
a control unit configured to control the rotational force given by the power source depending on an output of the magnetic detection unit in a state where the first of the rotatable members is relatively rotated through a predetermined rotational angle.

10. A power assist wheelchair comprising the torque control device as recited in claim 9.

11. A power assist straddle-type vehicle comprising the torque control device as recited in claim 9.

12. A power steering device comprising the torque control device as recited in claim 9.

13. The relative rotational angular displacement detection device of claim 1, wherein the one cycle of the electrical angle corresponds to one pair of the magnetic poles, that includes a north pole and a south pole adjacent each other, and one cycle of the mechanical angle corresponds to an entire circumferential width formed by the one pair of the magnetic poles in the circumferential direction.

14. A relative rotational angular displacement detection device, comprising:
a pair of rotatable members rotatable by 360 degrees about an axis of rotation, the rotatable members being rotatable relative to each other about the axis of rotation in a circumferential direction;
a permanent magnet attached to one of the pair of rotatable members so as to rotate with the one rotatable member, the permanent magnet including magnetic poles arranged so as to alternate in polarity in the circumferential direction of the axis of rotation;
a magnetic flux guiding ring including
a plurality of protruding portions arranged at positions facing the magnetic poles,
an annular ring body attached to the other of the pair of rotatable members so as to rotate with the other rotatable member, the annular ring body arranged coaxially with the axis of rotation, the annular ring body magnetized with a strength of magnetization changing depending on positions of the protruding portions relative to positions of the magnetic poles; and
a magnetic detection unit configured to detect magnetic fluxes of the ring body, the magnetic detection unit including
a plurality of facing portions that are spaced apart from each other with respect to the circumferential direction, each of the facing portions being arranged to face a different part of the ring body than that of the other facing portions and configured to receive magnetic fluxes of the part of the ring body,
magnetic sensors configured to detect the magnetic fluxes received by the facing portions, and
the facing portions being configured such that their relative positions with respect to the circumferential direction of the axis of rotation are fixed independently of rotation of the permanent magnet and the magnetic flux guiding ring about the axis of rotation,
the magnetic detection unit includes M pieces of the facing portions,
the facing portions are arranged at the positions such that an angle formed between adjacent ones of the facing portions satisfies a relational expression of:
(a value of a mechanical angle corresponding to one cycle of an electrical angle of the permanent magnet)×N+(the value of the mechanical angle corresponding to the one cycle of the electrical angle of the permanent magnet)/(M),
where N represents positive integers, and M is a total number of the facing portions.

15. The relative rotational angular displacement detection device of claim 14, wherein the one cycle of the electrical angle corresponds to one pair of the magnetic poles, that includes a north pole and a south pole adjacent each other, and one cycle of the mechanical angle corresponds to an entire circumferential width formed by the one pair of the magnetic poles in the circumferential direction.

16. A relative rotational angular displacement detection device, comprising:
a pair of rotatable members rotatable by 360 degrees about an axis of rotation, the rotatable members being rotatable relative to each other about the axis of rotation in a circumferential direction;
a permanent magnet attached to one of the pair of rotatable members so as to rotate with the one rotatable member, the permanent magnet including magnetic poles arranged so as to alternate in polarity in the circumferential direction;
a magnetic flux guiding ring including
a plurality of protruding portions arranged at positions facing the magnetic poles,
an annular ring body attached to the other of the pair of rotatable members so as to rotate with the other rotatable member, the annular ring body arranged coaxially with the axis of rotation, the annular ring body magnetized with a strength of magnetization changing depending on positions of the protruding portions relative to positions of the magnetic poles; and
a magnetic detection unit configured to detect magnetic fluxes of the ring body, the magnetic detection unit including
a plurality of facing portions that are spaced apart from each other with respect to the circumferential direction, each of the facing portions being arranged to face a different part of the ring body than that of the other facing portions and configured to receive magnetic fluxes of the part of the ring body,
magnetic sensors configured to detect the magnetic fluxes received by the facing portions, and
the facing portions being configured such that relative positions of the facing potions with respect to the circumferential direction are fixed independently of rotations of the permanent magnet and the magnetic flux guiding ring about the axis of rotation,
the magnetic detection unit includes M pieces of the facing portions,
the facing portions are arranged at the positions such for each respective facing portion of the facing portions, an angle formed by the respective facing portion and an adjacent one of the facing portions satisfies a relational expression of:
(a value of a mechanical angle corresponding to one cycle of an electrical angle of the permanent magnet)×N+(the value of the mechanical angle corresponding to the one cycle of the electrical angle of the permanent magnet)/(M),
where N represents a positive integer, and M is a total number of the facing portions.

17. The relative rotational angular displacement detection device of claim 16, wherein the one cycle of the electrical angle corresponds to one pair of the magnetic poles, that includes a north pole and a south pole adjacent each other, and one cycle of the mechanical angle corresponds to an entire circumferential width formed by the one pair of the magnetic poles in the circumferential direction.
